(19) United States
(12) Patent Application Publication
(10) Pub. No.: US 2004/0012126 A1
(43) Pub. Date: Jan. 22, 2004

(54) Blow molding method and apparatus, and metallic mold apparatus and a needle blow nozzle

(75) Inventors: Yoshitaka Ohno, Kanagawa-Ken (JP); Toshio Kagitani, Kanagawa-Ken (JP); Sohei Masaki, Kanagawa-Ken (JP); Shoji Abe, Kanagawa-Ken (JP); Katsumi Kohama, Saitama-Ken (JP); Takatoshi Watanabe, Saitama-Ken (JP)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignees: Yachiyo Industry Co., Ltd.; The Japan Steel Works, Ltd.

(21) Appl. No.: 10/391,962

(22) Filed: Mar. 19, 2003

(30) Foreign Application Priority Data
Jul. 22, 2002 (JP) 2002-212235

(51) Int. Cl. B29C 49/60

(52) U.S. Cl. 264/523; 425/536

(57) ABSTRACT

The object of the present invention is to cool forcibly the upper and the lower clamp portions of the parson using the upper and the lower blow holes of respective needle blow nozzle synchronously, the metallic mold is cooled by using the cooling apparatus inside the wall, thereby shorten molding cycle time and stabilize the quality. The blow molding method and apparatus, and metallic mold and needle blow nozzle of the present invention are constructed so that an upper and a lower needle blow nozzles (1a, 1) are inserted into said parison (59) to cool respective clamp portion (59c, 59d) forcibly, the discharge nozzle (1b) discharge air, and the molding parson (59) in the internal side of the metallic mold (40A) is cooled by the cooling apparatus (600) disposed inside of the metallic mold (40A), so as to shorten molding cycle time.

### FIELD OF THE INVENTION

The present invention relates to a blow molding method and apparatus, metallic mold apparatus and a needle blow nozzle. More particularly, the present invention relates to a novel improvement in which a pair of needle blow nozzle are inserted into a parison with air to be jetted only to the upper and lower clamp portions of the parison, meanwhile the discharge nozzles disposed among respective blowing nozzles discharge air, cool the metallic mold, thereby shorten the cooling time of the molded product and shorten the time of molding cycle by lowering the extruded resin to a lower temperature and by cooling for shaping.

### BACKGROUND OF THE INVENTION

FIGS. 10-18 show a structure of a conventional blow molding method and apparatus disclosed in Japanese Unexamined Patent Publication No. 2000-102971, in which the structure of a crosshead used in blow molding is shown in FIG. 19, which disclosed in Japanese Unexamined Patent Publication No. 2000-102963.

Namely, in FIG. 10, numeral 1 denotes a needle blow nozzle used in a blow molding apparatus 2 shown in FIGS. 13, 14 and 16. The needle blow nozzle 1 comprises a base portion 3, a tubular body 4, and a needle portion 5 at a fore end. The tubular body 4 is in the form of a double tubular structure consisted by a first tubular portion 4a and a second tubular portion 4b. Further, the tubular body 4 is not limited to the illustrated double tubular structure, and it may be formed of one tubular portion 4a or 4b, that is a single tube.

An air inlet 6 is formed in the first tubular portion 4a, and an air outlet 7 is formed in the second tubular portion 4b. Further, air suction ports 8 are formed at a fore end of the second tubular portion 4b. The air suction ports 8 are communicated with the air outlet 7 through a second blow portion 4bA defined in the second tubular portion 4b.

As also shown in FIG. 12, the needle portion 5 is formed to have an umbrella-like shape in its entirely, and a pinged needle center 9 at the tip of the needle portion 5 is positioned at an axis of the tubular body 4. Four (or two instead of four) elongate cutting areas 10 are formed in an outer peripheral surface of the needle portion 5, and gradually spread away from the needle center 9 as the apex. The elongate cutting areas 10 have slopes 11 formed to provide edges extending from the needle center 9 at an acute angle, e.g., about 30 degrees. With the presence of the slopes 11, the needle portion 5 is formed into an umbrella-like shape having an acute apical angle.

A total of four (or at least two) nozzle holes 20 for jetting air is formed near the base of the needle portion 5 between the elongate cutting areas 10. The nozzle holes 20 are each communicated with the air inlet 6 through a first blow portion 4aA defined in the first tubular portion 4a. The needle portion 5, the first tubular portion 4a, the second tubular portion 4b, and the base portion 3 are mechanically machined as separate parts. These parts are joined to each other at their joint portions by welding or brazing. If the joined parts are misaligned after the welding or brazing, the parts are machined for centering and rejoined repeatedly so that the needle center is properly positioned at the center of the needle blow nozzle 1 and the needle blow nozzle 1 can develop its ability to easily pierce into a parison 59.

The structure of needle blow nozzle 1 is shown in FIG. 15, high-pressure air 30a from a high-pressure air source 30 is pre-cooled by an air cooling apparatus 31, and is then supplied to the air inlet 6 of the needle blow nozzle 1 via a pre-blow circuit 100 and a main blow circuit 101 which constituted by a check valve 32 and two valves 33 and 34. After circulating through the needle blow nozzle 1 with the needle portion 5 covered by a cap-like circulation jig 200, the high-pressure air 30a is sent from the air outlet 7 to a circulating circuit 202, which includes valves 36, 36A. With such an arrangement, the high-pressure sir 30a is cooled while circulating through the needle blow nozzle 1. In other words, the arrangement of FIG. 15 is that the to pre-cool air before the needle blow nozzle 1 is inserted into the parison 59, and after completion of the pre-cooling, the circulation jig 200 is removed and the needle blow nozzle 1 is inserted into the parison 59.

In this connection, the valve 36 in the discharge side functions as a low-pressure valve to hold the constant inner pressure in the circulation jig 200, thereby establishing a large difference pressure between the high-pressure blown air and the low-pressure discharged air. When the needle blow nozzle is inserted into the parison 59, the blown air is positively cooled due to adiabatic expansion occurred at the fore end of the needle blow nozzle 1. As a result, the ability of cooling the interior of a molded product 70 can be enhanced and the molding cycle can be shortened in comparison with the conventional cycle. Also, to evacuate the inner air pressure in the molded product 70 in a shorter time, the high-pressure air 30a supplied from the valves 33, 34 and the circuits 100, 101, shown in FIG. 15, is stopped, and the valves 35, 36A are driven to operate so that the interior of the molded product 70 is quickly opened to the atmosphere through the circuits 100, 102 and silencers 35B, 36B. As a result, the inner air pressure in the molded product 70 is reduced to the atmospheric pressure and the molding cycle is shortened.

The air-cooling apparatus 31 is provided in a base 50 of the blow molding apparatus 2 shown in FIGS. 6 and 7. A pair of backboards 55, 56 are associated respectively with the first and second fixed plates 51, 52 which are provided in the vase 50 in such a manner as can be opened and closed by actuators 53, 54 such as motors. Molds 40, 41 define a cavity 42 of the metallic mold 40A are attached respectively to the backboards 55, 56 in such a manner as can be opened and closed. The parison 59 is ejected from a crosshead 57 and is molded by the moles 40, 41 clamped together. A plurality of needle blow nozzles 1 are connected to the air cooling apparatus 31 through connecting tubes 60, and are installed to move back and forth freely by cylinders a, which are provided on the backboard 56 through fixed members 1b. The needle blow nozzles 1 are disposed to reach the interior of the cavity 42 after penetrating a through hole 56a in the backboard 56 and a through hole 41a in the second metallic mold 41. As shown in FIG. 16, each of the cylinders 1a connected via hoses 81, 82 to a solenoid valve 80 for controlling the operation of the cylinder 1a, and the solenoid valve 80 is connected to a driving source 84 and a silencer 83 via lines 85, 89. A reservoir tank 86 is provided to compensate for deficiency of pressure supple from the driving source 84. For driving the cylinder 1a at a high speed, the pressure from the driving source 84 is increased, and the solenoid valve 80, flow passages of the lines 81, 82, 85, 89 and the silencer 83 are constructed so as to increase an air flow rate. The cylinder 1a is thereby operated at a high speed so that the needle blow muzzle 1 is easily inserted into the parison 59. Because of the parison 59 being formed of a molten resin and having elasticity, if the cylinder 1a is operated not at a high speed but a low speed, the resin would coil around the needle portion 5 of the needle blow nozzle 1 connected to a fore end of the cylinder 1a, When the cylinder 1a is operated at a low speed the needle portion 5 would not pierce the parison 59. Thus, as shown in FIG. 16, the blow molding apparatus 2 is constructed such that the needle blow nozzle 1 is laterally inserted into the parison 58 within the molds 40, 41 for blowing air through the nozzle.

The operation of the blow molding apparatus 2 will now be described. First, the air pre-cooling operation is performed with the circulation circuit 102, shown in FIG. 15, in a condition where the molds 40, 41 are kept open. The circulation jig 200 is removed after completion of the pre-cooling, then, as shown in FIG. 16, the parison 59 is ejected from the crosshead 57 to extend downward vertically, and is pinched at its lower end by a pincher (not shown). In the pinched condition, the parison 48 is held by the molds 40, 41 while pre-blow is applied to the interior of the parison 58 from the crosshead 57 and the molds 40, 41 are gradually closed. Then, the molds 40, 41 are completely closed while the cylinders 1a are operated to insert the needle blow nozzles 1 into the parison 48 for supply of the high-pressure air 30a. After the closing of the molds 40, 41 are completed; the high-pressure air 30a is supplied to perform blow molding. At this time, since the fore end of the needle portion 5 has an umbrella-like shape, even the needle blow nozzles 1 each having a larger diameter than conventional can be smoothly inserted into the parison 59. Accordingly, the air can be much more easily supplied than conventional, and supply of a large amount of the air forces the parison 59 to be rapidly inflated so as to contact and transfer onto inner walls of the molds 40, 41 in a moment. This results in much better transfer property of the molded product than conventional.

When the high-pressure air 30a from the high-pressure air source 30 is supplied while the needle blow nozzles 1 are inserted into the parison 59, as described above, the fifth valve 36 in the discharge side functions as a low-pressure relief valve to hold constant the inner pressure in the parison 59, thereby establishing a large different pressure between the high-pressure blown air and the low-pressure discharged air. Accordingly, the blown air is positively cooled in the parison 59 due to adiabatic expansion occurred at the fore end of the needle blow nozzle 1, and the ability of cooling the interior of the parison 59 can be enhanced. The molded product can be thus rapidly cooled in combination with the aforementioned air-cooling effect achieved by the air-cooling apparatus 31. While the two nozzles 1 are used in FIG. 16, a single nozzle may be provided. Also, a single cylindrical wall tube t may be adopt in place of the two nozzles 1 and used such that the air is injected into by one nozzle and discharged out by other nozzle.

As shown in FIGS. 17 and 18, a blow-molded product 70 formed by the above-described blow molding has a pair of mouths 70a, 70b through which the needle blow nozzles 1 have been inserted. More specifically, just after the blow molding, each mouth 70a, 70b has a shape shown in (A) of FIG. 18, and a hole 70c through which the needle blow nozzle 1 have been inserted is formed as shown. By cutting off an upper end of the mouth 70a, 70b((B) of FIG. 18). As a result of removing the upper end of the mouth including the hole 70c, a large hole is formed in the blow molded product 70, whereby refuse in the blow molded product 70 can be easily cleaned up and a device to be installed within the blow molded product 70 can be increased in size and can be more easily installed. In other words, since the muzzles 1 are laterally inserted into the blow molded product 70 through the mouths 70a, 70b, pinched portions 59c, 59d are nor required to hake such a large thickness as needed conventionally, and the wall thickness of the blow molded product 70 can be reduced. A reduction of the blow-molded product 70 can be reduced. A reduction or the wall thickness also contributes to increasing an inner volume of the blow-molded product 70 and cutting down the material cost.

Moreover, since the muzzles are not inserted through the pinched portions 59a, 59b, the pinched portions can be formed into a simple shape that is advantageous in avoiding stress from concentrating to those portions and ensuring a high degree of strength.

FIG. 19 is a schematic diagram showing an overall structure of the above crosshead drop into the metallic mold 40A of the above blow molding apparatus. That is to say, the member denoted by numeral 57 is a crosshead, the crosshead is constructed to be connected to first to sixth extruders 302-307, where a main material outer layer 302a, a main material inner layer 303a, a pulverized material layer 304a, a barrier layer 305a, an adhesive inner layer 306a, and an adhesive outer layer 307a are supplied from the first extruder 302, the second extruder 303, the third extruder 304, the fourth extruder 305, the fifth extruder 306, and the sixth extruder 307, respectively.

In the crosshead body 57, first to sixth ring-shaped annular passages 308-313 are formed, wherein the main material order layer 302a, the main material inner layer 303a, the pulverized material layer 304a, the barrier layer 305a, the adhesive inner layer 306a, and the adhesive outer layer 307a are supplied to the first annular passage 10, the fourth annular passage 11, the fifth annular passage 12, and the sixth annular passage 13, respectively, such that a parison 59 integrally formed of, from the outside, the main material order layer 302a, the pulverized material layer 304a, the adhesive order layer 307a, the barrier layer 305a, the adhesive inner layer 306a, and the main material inner layer 303a, flows down at a constant velocity after discharged from a die slit 322 and a die slit discharge-outlet 323 of a die 321. As shown in the right side of FIG. 19, the crosshead body 57 is vertically formed of a passage 301A, a multiplayer forming section 301B, and an adhesive property activating section 301C for adhering.

The conventional blow molding method and apparatus configured as above has the following problems.

That is, when the parison is clamped by metallic mold for molding the metallic mold is closed, but at this time, the upper portion and the lower portion of the metallic mold contact each other when the metallic mold is closed. At the beginning of the close operation of the metallic mold, the metallic mold contacts the parison. With this contact, in order to cool the contact portion, the blow ratio of the upper portion and the lower portion of the metallic mold (expansion ratio caused by no pressure) may be reduced.

For which, it is necessary to increase the wall thickness of the upper and the lower clamp portion. Moreover, in the sectional view showing the wall thickness of the upper and the lower clamp portions shown in FIG. 20,when the contact portion of the parison inner surface is the thinner section of FIG. 20, the strength of the contact of the upper and the lower clamp portion inner surface will be reduced, and become concave shape with a concentrating stress under the outer force. So, the thickness of this portion should be increased duo to molding condition, and become convex shape wall shown in FIG. 21 by the shape of the clamp portion of the metallic mold.

Thus, the contact area of the parison inner surface of the upper and lower clamp portion is increased, the strength is increased, and the strength against shock increases due to being convex shape.

Thus, the thicker the wall of the blow molded product of the upper and the lower clamp portion, the more important the cooling time of the molded product of large vessel. Thus, it is difficult to cool the thicker wall of the upper and the lower clamp portion, the described temperature for taking out molded product depends on the cooling capacity of the upper and the lower clamp portions, there is problem of increasing period of the molding cycle.

Moreover, in the extruder used for the pulverized layer, which extrude the pulverisized layer in the above multi layer crossheads, the regenerated material made up with 92% of main material (polyethylene with high density), 5% of barrier material (EVOH), and 3% of adhesive materialis used as the layer.

The regenerated material is pulverized material about 10 mm by pulverizing the upper and lower overflow material and the waster or the like in a pulverizer, and is sent to an extruder for pulverizing material by a material supply apparatus, and the barrier material (EVOH) is pulverized into material smaller than 10μ. The EVOH of the barrier material is formed into a film layer about 100μ (one layer of the multi-layer) in the upper and lower overflow material and product until it is feed into the extruder.

For which, in the layer made up of main material 92%, EVOH 5%, adhesive material 3%, when the EVOH dispersed in the extruder is more than 10μ, EVOH become the foreign material in main material, like the foreign material in mental, it causes stress concentration portion about the EVOH, and result in the portion to be destroyed easily.

To prevent this phenomenon, it is desired to divided the EVOH into smaller than 10μ. But, in order to divide the EVOH, it is desired to exert a strong shear to the EVOH, but the main material may become hot, the temperature of the resin may increase rapidly up to about 300 degree Centigrade if the shear is exerted to the main material.

### SUMMARY OF THE INVENYION

The present invention aims to solve the problems set forth above, an object of the present invention is to provide a blow molding method and apparatus, and a metallic mold apparatus and a needle blow nozzle, with which a pair of needle blow nozzles are inserted into the parison, the metallic mold are cooled by the discharge air discharger by the nozzle between the respective needle blow nozzle, moreover, the time of cooling the blow molded product can be reduced by lowering the temperature of resin extruded and by use of deform cooling, and thereby shortening the time of molding cycle.

The method of the present invention includes: the material extruded from many extruder form multiplayer parisons by passing through crosshead, the upper and the lower needle nozzles are inserted the parison reserved in the metallic mold used for blow mold, thus obtains a blow molded product by ejecting air toward said parison, in which, said metallic mold is cooled by the cooling apparatus, the upper clamp portion and the lower clamp portion formed on the upper and the lower portion of said parison are cooled by air passed only through the upper discharge hole formed on said upper needle blow nozzle and said lower needle blow nozzle, and said parison is formed and the blow molded product is cooled by discharging air of said parison through the discharge nozzles formed between said respective needle blow nozzle and pierceed into said parison. Also, said cooling apparatus is disposed on the upper and the lower portion of the metallic mold. Moreover, the EVOH in polyeylene is pulverized by said extruder, and supplied to crosshead under low temperature of 200 degree centigrade. A blow molding apparatus of the present invention includes: the material extruded from many extruder form multiplayer parisons through crosshead, the upper and the lower needle nozzles are inserted the parison reserved on the metallic mold used for blow mold, thus obtains a blow molded product by ejecting air toward said parison, in which, said metallic mold is cooled by the cooling apparatus, the upper clamp portion and the lower clamp portion formed on the upper and the lower portion of said parison are cooled by air passed only through the upper discharge hole formed on said upper needle blow nozzle and said lower needle blow nozzle, and said parison is formed and the blow molded product is cooled by discharging air of said parison through the discharge nozzles formed between said respective needle blow nozzle and pierceed into said parison. Also, said cooling apparatus is disposed on the upper and the lower portion of the metallic mold. Moreover, said cooling apparatus is disposed on the upper and the lower portion. A metallic mold apparatus, in which a parison drop from a crosshead clamped by a pair of first and second metallic molds, an upper and lower needle blow nozzles are inserted into said parison from an upper hole and a lower hole formed on side portion of said second metallic mold, where discharge hole is formed between said hole and lower hole, the nozzle used for discharge is inserted into said discharge hole. Furthermore, there disposed cooling apparatus in said respective metallic mold. A needle blow nozzle of the present invention is long shaft shape in overall shape, and is consisted by a shaft body with needle shape fore end and hole formed on said fore end, in which said hole is consisted by the upper discharge hole or lower discharge hole, and is formed only on the part of a pair of semicircular divided by a diameter line through the axle center of said shaft body.

### BRIEF DESCRIPTION OF THE DRAWINGS

FIG. 1 is a diagram of the structure of the blow molding apparatus of the present invention,

FIG. 2 is a schematic diagram of the operation of the main parts of FIG. 1,

FIG. 3 is a sectional view showing the essential portion of FIG. 1,

FIG. 4 is an enlarged left side view of FIG. 3,

FIG. 5 is an enlarged sectional view showing a part of metallic mold of FIG. 1,

FIG. 6 is an enlarged sectional view showing a part of FIG. 5,

FIG. 7 is a left side structure view showing essential portion of FIG. 5,

FIG. 8 is an explanation view showing a molding cycle of the present invention,

FIG. 9 is a diagram showing the characteristic of the cooling time and the molded product temperature of the conventional art and the present invention,

FIG. 10 is an sectional view showing a needle blow nozzle of the prior art,

FIG. 11 is an sectional view taken along line A-A of rear end of FIG. 10,

FIG. 12 is a right side view of front end of FIG. 10,

FIG. 13 is a main view showing a blow molding apparatus of prior art,

FIG. 14 is a right side view of FIG. 13,

FIG. 16 is an explanatory view showing a blow molding step using metallic molds shown in FIG. 13,

FIG. 17 is a perspective view of conventional blow molded product,

FIG. 18 is an explanatory view showing a mouth portion molding step and processed state of the blow molded product shown in FIG. 17,

FIG. 19 is sectional views of an crosshead of the prior art and the present invention,

FIG. 20 is a sectional view showing a part of conventional parison,

FIG. 21 is a sectional view showing a part of conventional parison,

Wherein:

| 1a | upper needle blow nozzle |
|---|---|
| 1 | lower needle blow nozzle |
| 40, 41 | first and the second metallic mold |
| 40A | metallic mold |
| 59 | parison |
| 70 | molded product |
| 57 | crosshead |
| 600 | cooling apparatus |
| 59c | upper clamp portion |
| 59d | lower clamp portion |
| 503 | upper nozzle hole |
| 503a | lower nozzle hole |
| 16 | nozzles for discharge air |
| 41a | upper hole |
| 41b | lower hole |
| 41c | air discharge outlet |
| 1B | shaft body |
| P | axle center |
| 501, 502 | semi circular portion |
| 500 | Diameter line |

### DETAILED DESCRIPTION OF THE INVENTION

Preferred embodiments of a blow molding method and apparatus, a metallic apparatus and needle blow nozzle according to the present invention will be described below with reference to the drawings.

The identical or equivalent parts to those the same numerals are denoted in the conventional example. Because the other constructions except the metallic mold 40A and the needle blow nozzles 1a, 1 are same as the conventional one, so the conventional constructions are used here.

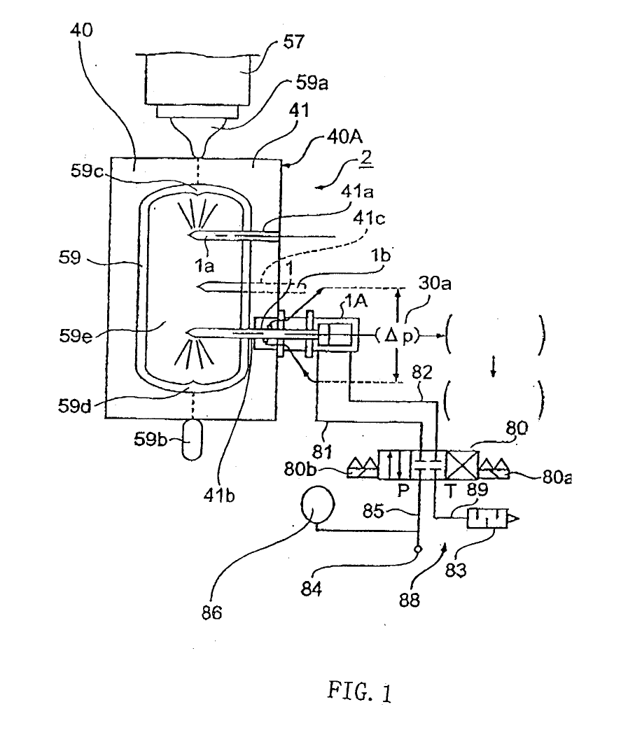

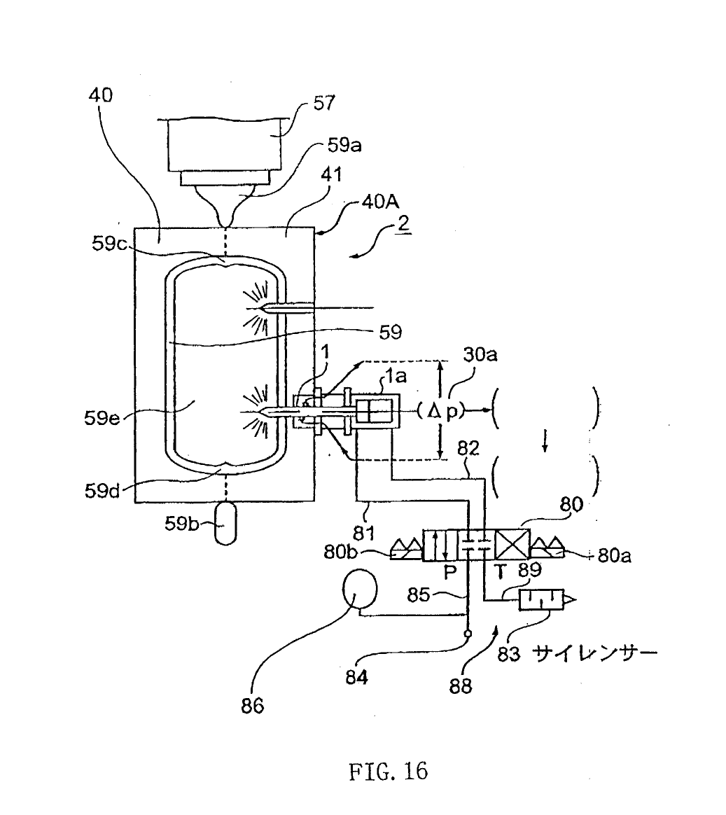

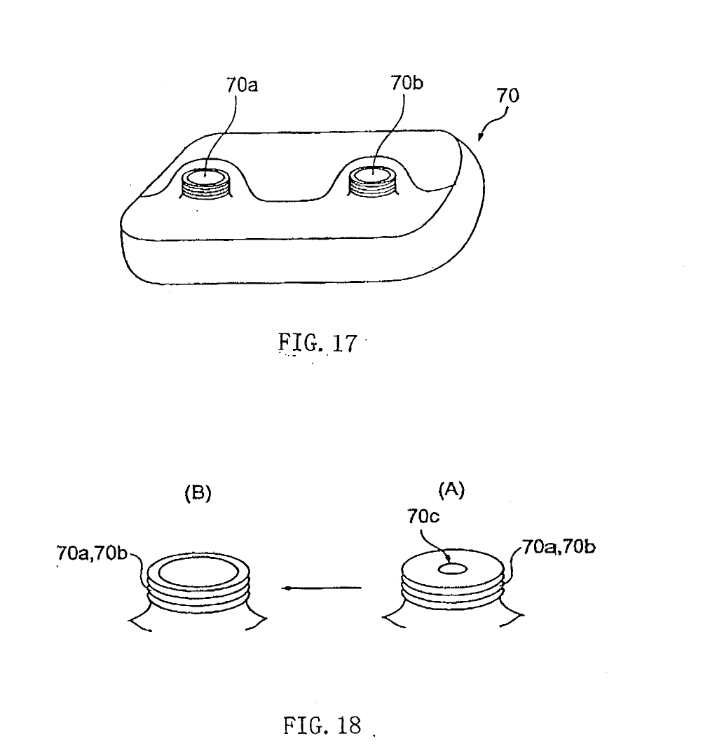

FIG. 1 shows the constructions of present invention acquired by modifying the conventional mold blow apparatus shown in FIG. 16, in which the identical parts are denoted by the same numerals, the explanation about them are omitted, and only the different parts with the FIG. 16 are explained.

That is to say, the upper needle blow nozzle 1a and the lower needle blow nozzle 1 are constructed to be inserted into the upper hole 41a and the lower hole 41b on the side portion of the second metallic mold 41 of the metallic mold 40A formed by the first metallic mold 40 and the second metallic mold 41, the nozzles pierce into the parison, the nozzles for discharge 1b is constructed to be inserted into the discharge hole 41c between the above holes 41a and 41b, and pierced into parison 59.

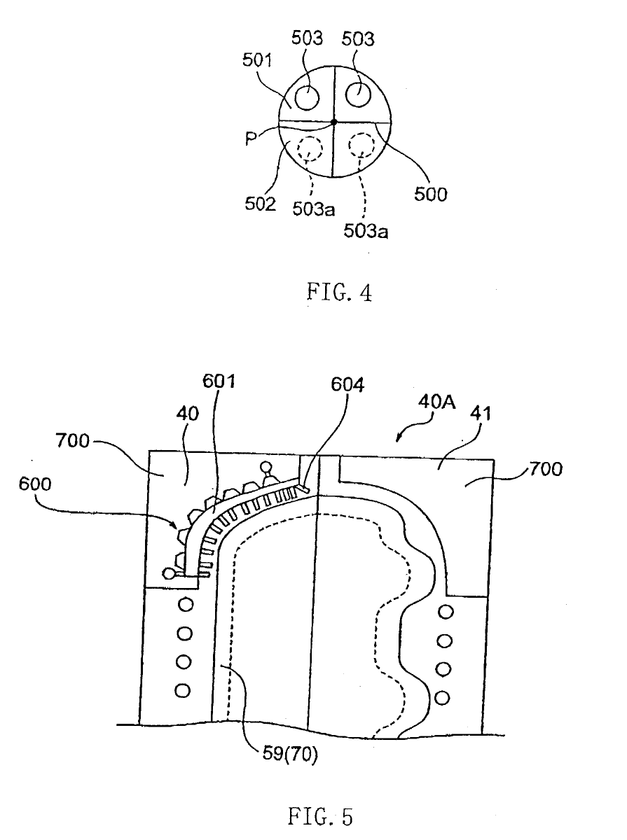

In the above needle blow nozzle 1a, 1, the upper needle blow nozzle 1a shown in FIGS. 3-4 is divided into a pair of semi circular portion 501 and 502 by the border of the diameter line 500 through the axle center P of which, and a upper nozzle hole is only formed on the upper portion of one of the semi circular portion 501 and 502.

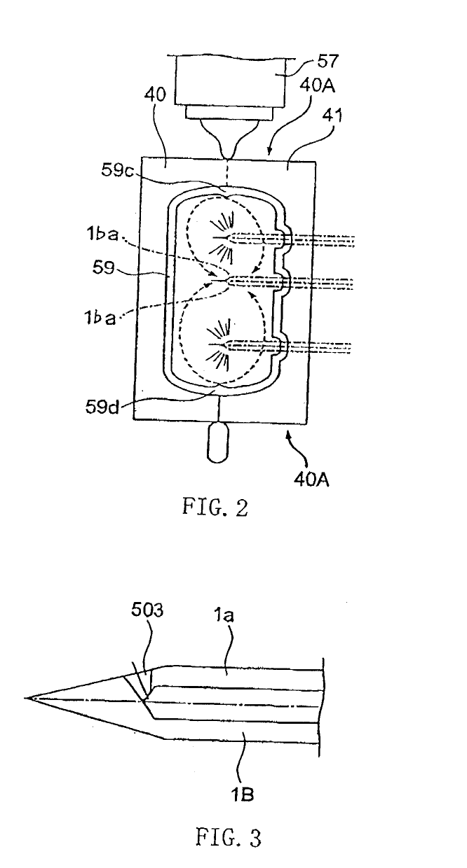

Moreover, in the above lower needle blow nozzle 1, the lower nozzle hole 503a such as dotted line is only formed on the semi circular portion 502 on the above lower side (not shown in figs), when it supply with low temperature high pressure air to respective needle blow nozzle 1a and 1, as showmen in FIG. 2, the upper and lower clamp portions 59c, 59d of the parison 59 formed in the metallic mole 40A can be cooled from the inner side (the air moving along the direction shogun by dotted line), meanwhile the discharge relay on the discharge hole 1ba of the above discharge blow nozzle 1b, and discharge form the metallic mold 40A inner to the out of the metallic mold 40A.

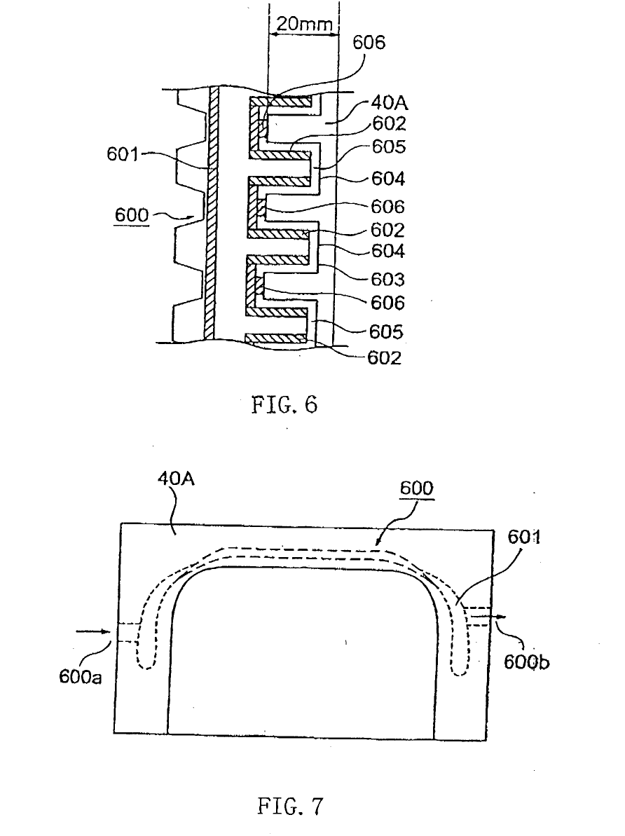

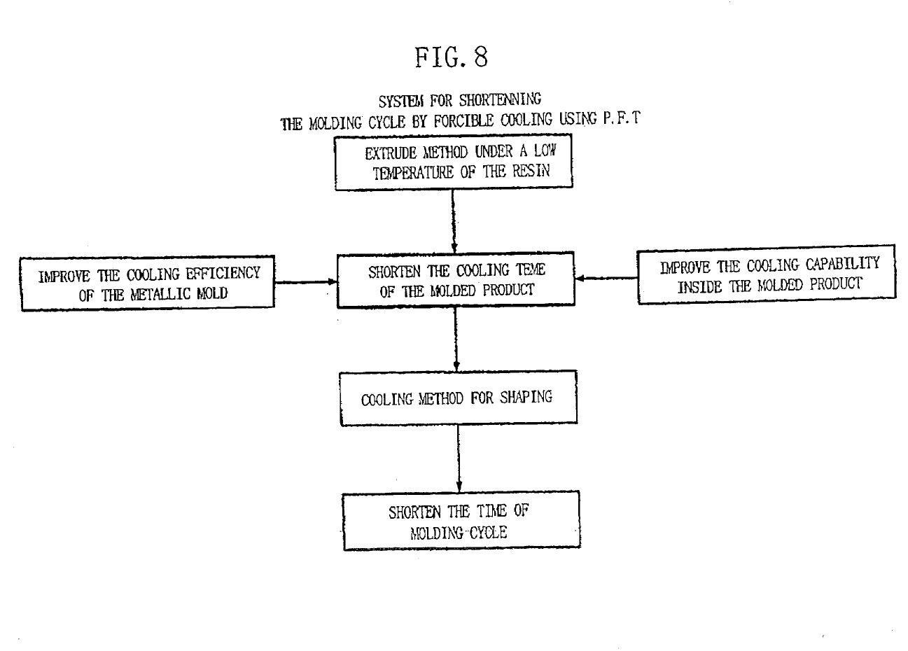

In the inner of the wall of the respective metallic mold portions 40, 41 wall of the above metallic mold 40A formed with a cooling apparatus 600 which provide spray water to cool the metallic mold 40A, an example of the cooling apparatus 600 is shown in FIGS. 5 and 6, on the side wall passing the tube 601 of spray water, many protruded tubular protruding tubes 602 form with many shapes such as distributor, the respective protruding tube 602 correspond to respective concave portion 604 of the concave-convex portion 603 formed in the metallic mold 40A wall. Moreover, on the outer side of the tube 601, there formed with block body 700 which can be equipped on respective metallic mold 40, 41 to cover the tube 601.

There disposed separating plate 606 between the concave-convex 603 and the protrude tube 602 to supply with spray water to the tube 601, and to eject spray water from respective protrude tube 602 to the concave portion 604, so as to cooling the cavity i.e. the inner side wall of the metallic mold 40A.

Moreover, in the center of the metallic mold 40A, disposed with known tube cooling apparatus (shown as section circular), one example of the cooling apparatus 600 can also use other known cooling water jacket, which can be equipped on the upper portion, lower portion and side portion etc of the metallic mold 40A as required. There is a gap about 5 mm between the above concave portion 604 and the inner surface of the cavity of the metallic mold 40A, while the diameter of the protrude tube 602 is about 10 mm, so as to improve the cooling effect on the inner parison 59 largely.

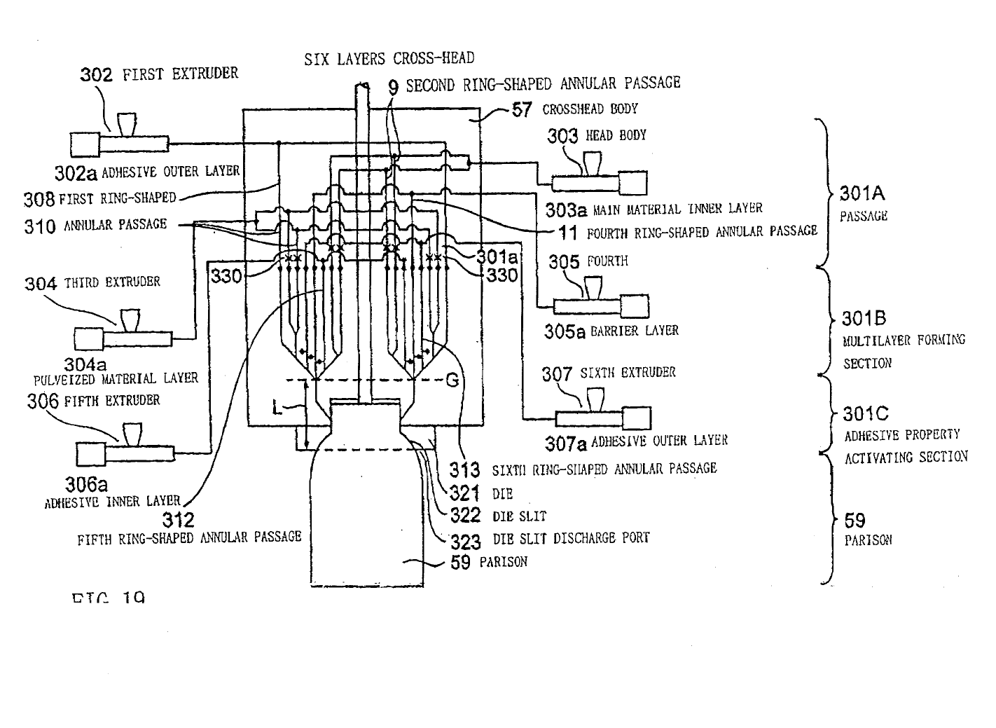

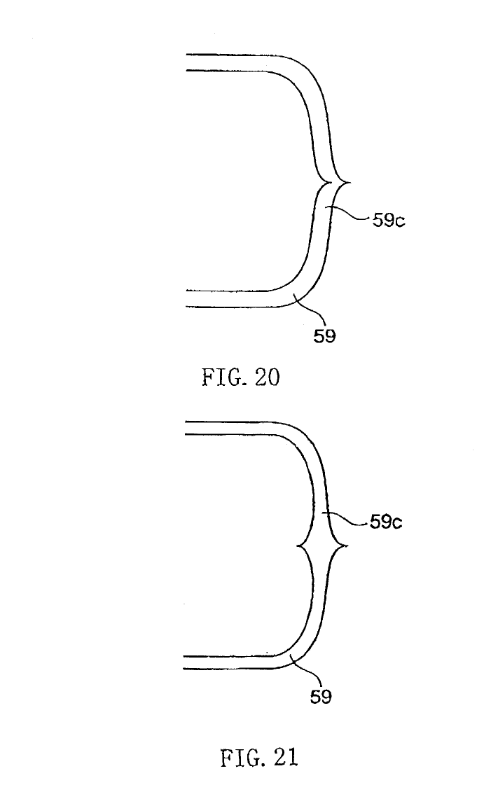

Moreover, because the construction of the crosshead 57 in FIG. 1 is the same as that in FIG. 19, so the contractor in FIG. 19 can be used, but the main material i.e. the above EVOH in the polythylene of the above regenerative material can be pulverized by the apparatus which can shear many times by means of the mechanical lower shear not shown in figs, and can be forced out by the extruder under the lower temperature about 200 degree centigrade and can extrude resin parison 59 of multiplayer construction about lower temperature of 200 degree centigrade in the multiplayer crosshead 57.

The operating action of the present invention can be explained below. In the above construction, an extruder with single axle in which L/D being 28 above is used to flap the multiplayer parison 59 made up of the above resin material under lower temperature in the metallic mold 40A, and close the mold, under the state of clapping the upper portion and the lower portion of the parison 59, when the upper needle blow nozzle la and the lower needle blow nozzle 1 are inserted from the side portion of the metallic mold 40A to supply with high pressure air, air is ejected from the upper discharge 503 of the upper needle blow nozzle 1a to the upper clamp portion 59c, and cooling it, meanwhile, air is ejected from the lower discharge 503a of the lower needle blow nozzle 1 to the upper clamp portion 59d to cool it.

In the above state, the parison 59 in the mold blow can be effectively cooled by the discharge hole 1ba of the discharge nozzle 1b discharges air outward.

In the above state, metallic mold 40A can be cooled by spray water by the cooling apparatus 600 disposed in the wall of the metallic mold 40A, in which the spray water of the cooling apparatus is supplied circuitry toward the discharge outlet 600b from the inlet 600a.

In the above cooling apparatus 600, corresponding to the inner side of the metallic mold 40A, the wall corresponding to the concave portion 604 is very thin (it is proportional to twice of the wall thickness in theory), so the cooling capacity can be improved largely, and because the spray water is ejected toward the concave portion 604 from respective protrude tube 602, the heat in the parison 59 on the inner side of the metallic mold 40A i.e. the blow molded product 70 can be cooled effectively.

Moreover, corresponding to the pressure 14 kg/cm2 in the parison 59 i.e. the inner side of the blow molded product 70, the portions without hole on the metalloid mold 40A become support portions.

The function of the present invention can be classified as below base on the descriptions above.

(1) In a single axel extruder (not shown in drawings), the thermoplastic melt resin is extruded by the extruder under resin temperature as low as possible, multi-layer structure is formed by crosshead 57, and the parison 59 is extruded under low temperature of the resin.

(2) The cooling effective of the upper and lower clamp portions 59c and 59d increases by means of disposing the fore hole of the respective needle blow nozzle 1a, 1 towards the upper and the lower clamp portions 59c and 59d and blowing the cooling and press air through inside of the molded product.

(3) The internal cooling efficiency increases by means of the discharge nozzle 1b disposed between respective needle blow nozzles 1a, 1 and in the center of the molded product which can distribute the cooling air for cooling inside of the molded product more effectively.

(4) The capacity of cooling from outward of the molded product can be improved by means the cooling apparatus 600 disposed in the metallic mold 40A wall, and the cooling capacity of the upper and the lower clamp portion 59c and 59d.

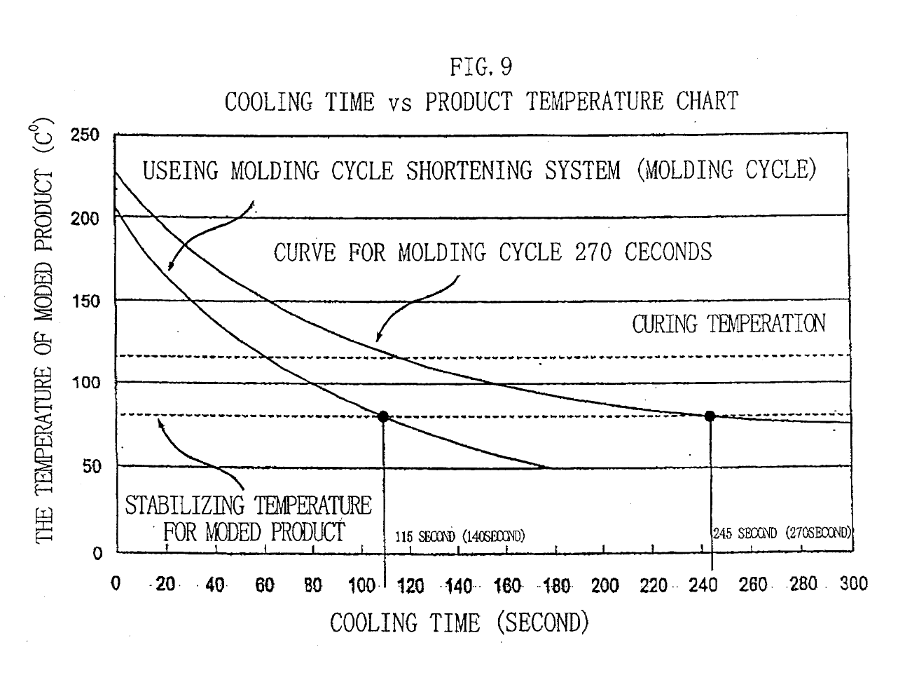

By such cooling method shown in FIG. 9, the cooling capacity of the upper and lower clamp portions 59c and 59d can be improved, thereby shorten the time of molding cycle.

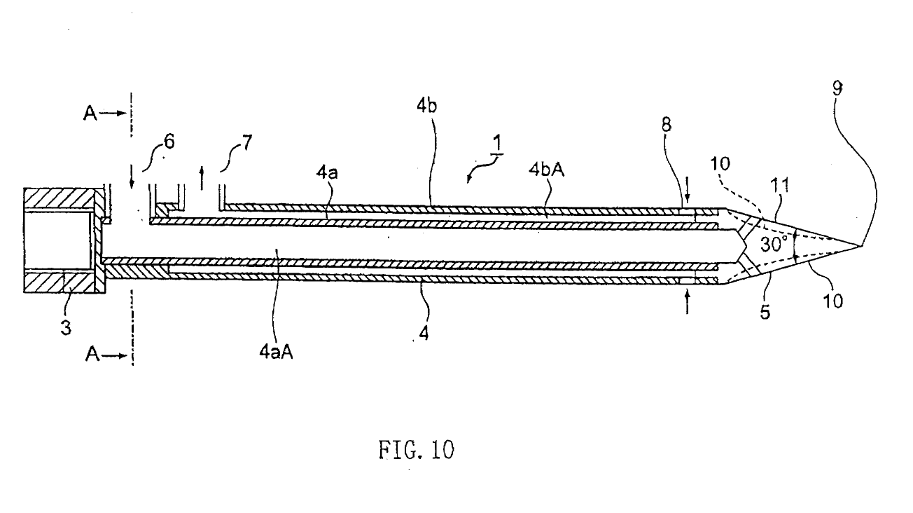

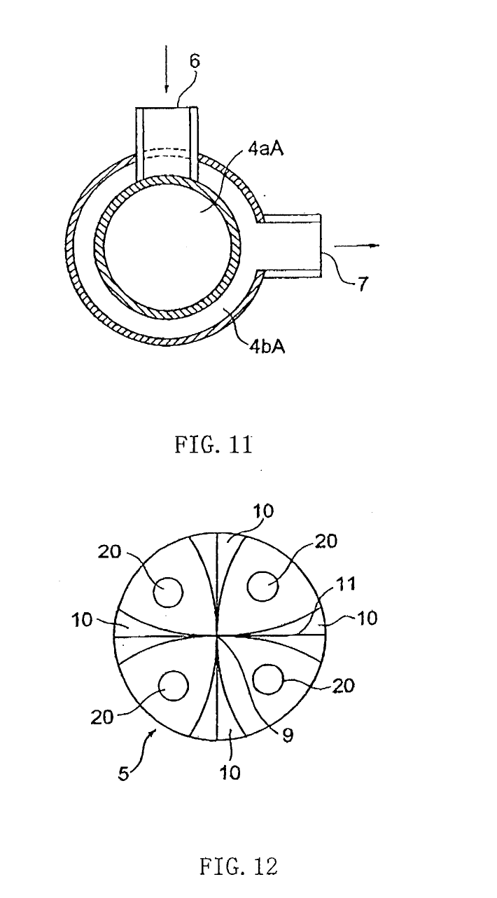

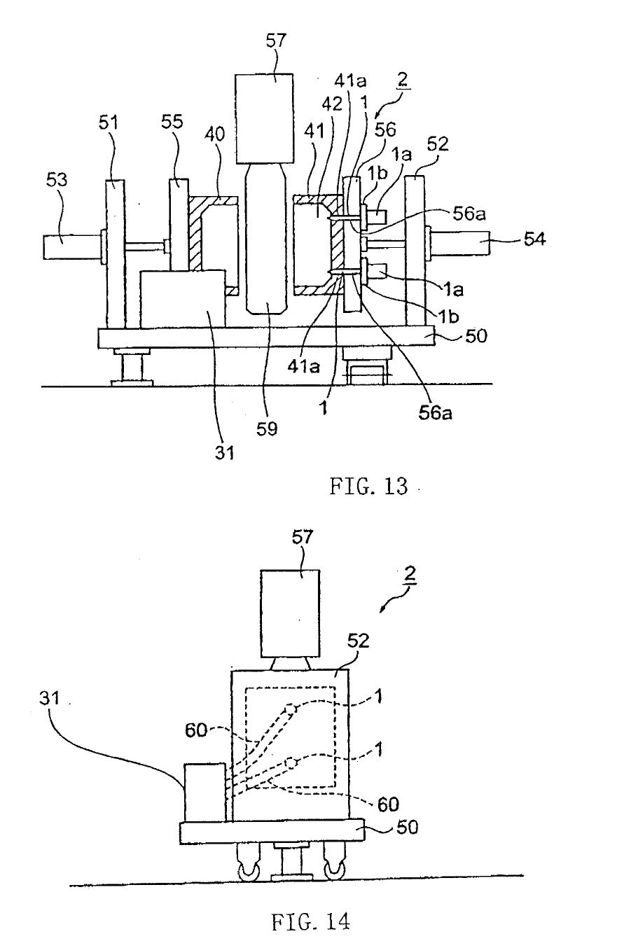

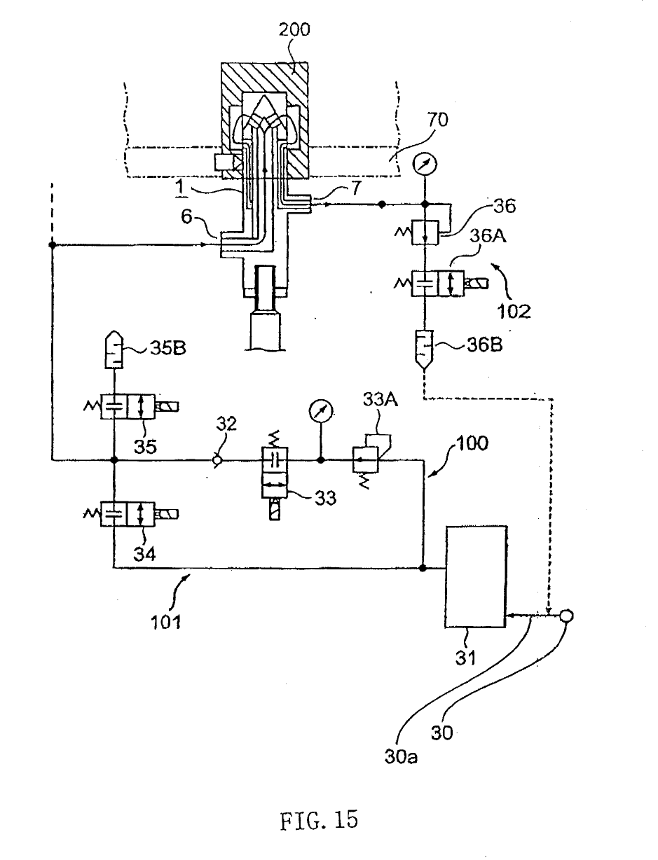

Moreover, the above cooling time and the temperature character of the molded product is shown in FIG. 10, the shape molding time of the conventional molded product is 245 seconds, but that of the present invention is 115 seconds. The molding cycle time can be shortened from conventional 270 seconds to the 140 seconds of present invention.

Because of using the above construction, the blow molding method and apparatus as well as metallic mold apparatus and needle blow nozzle can achieve the effect as follows.

That is, the amount of heat supplied to thermal mold can be reduced by extruding parison under lower temperature, moreover the amount of heat supplied to large blow molding product can be reduced by means of the cooling apparatus disposed on the metallic mold, and cool with high cooling efficiency can be realized, the time of molding cycle can be largely shorten, so the productivity of the large molding product can be improved. Moreover, the deform of the molded product after taken out can be reduced, and the quality of subsequent procedure for assembling the parts having holes can be stabilized.

1. A blow molding method includes: the material extruded from many extruder form multiplayer parisons (59) by passing through crosshead (57), the upper needle nozzles (1a) and the lower needle nozzles (1) are inserted into parison (59) reserved in the metallic mold (40A) used for blow mold from the side of the metallic mold (40A), thus obtains a blow molded product (70) by ejecting air toward said parison, characterized in that said metallic mold (40A) is cooled by the cooling apparatus (600), the upper clamp portion (59c) and the lower clamp portion (59d) formed on the upper and the lower portion of said parison are cooled by air passed only through the upper discharge hole (503) formed on said upper needle blow nozzle (1a) and the lower discharge hole (503a) formed on said lower needle blow nozzle (1), and said parison (59) is formed by discharging air of said parison (59) through the discharge nozzles (1b) formed between said respective needle blow nozzle (1a, 1) and pierced into said parson (59) and the blow molded product (70) is cooled.

2. A blow molding method according to claim 1, characterized in that said cooling apparatus (600) is disposed on the upper and the lower portion of the metallic mold (40A).

3. A blow molding method according to claim 1, characterized in that, the EVOH in polyeylene is pulverized by said extruder, and supplied to crosshead (57) under low temperature of 200 degree centigrade.

4. A blow molding apparatus, in which the upper needle nozzles (1a) and the lower needle nozzles (1) are inserted into the parison (59) reserved in the metallic mold (40A) used for blow mold, thus obtains a blow molded product (70) by ejecting air toward said parson (59), characterized in that said metallic mold (40A) is cooled by the cooling apparatus (600), the upper clamp portion (59c) and the lower clamp portion (59d) formed on the upper and the lower portion of said parison are cooled by air passed only through the upper discharge hole (503) formed on said upper needle blow nozzle (1a) and the lower discharge hole (503a) formed on said lower needle blow nozzle (1), and said parison (59) is formed and the blow molded product (70) is cooled by discharging air of said parison (59) by the discharge nozzles (1b).

5. A blow molding apparatus according to claim 4, characterized in that said cooling apparatus (600) is disposed on the upper and the lower portion of the metallic mold (40A).

6. A metallic mold apparatus, in which a parison (59) dropped from a crosshead (57) clamped by a pair of first and second metallic molds (40, 41), an upper needle blow nozzles (1a) and a lower needle blow nozzles (1) are inserted into said parison (59) from an upper hole (41a) and a lower hole (41b) formed on side portion of said second metallic mold (41), characterized in that on said side portion discharge hole (41c) is formed between said upper hole (41a) and lower hole (41b), the discharge nozzle (1b) is inserted into said discharge hole (41c).

7. A metallic mold apparatus according to claim 6, characterized in that A cooling apparatus is disposed within said respective metallic mold.

8. A needle blow nozzle, which is long shaft shape in overall shape, comprised of a shaft body (1B) with needle shape fore end and hole formed on said fore end, characterized in that said hole consisting of the upper discharge hole (503) or lower discharge hole (503a) is formed only on the part of a pair of semicircular (501, 502) divided by a diameter line (500) through the axle center (P) of said shaft body (1B).
